(19) United States
(12) Patent Application Publication
(10) Pub. No.: US 2025/0392988 A1
(43) Pub. Date: Dec. 25, 2025

(54) COMMUNICATION WITH VARIABLE CELL COVERAGE

(71) Applicant: Samsung Electronics Co., Ltd., Suwon-si (KR)

(72) Inventor: Aris Papasakellariou, Houston, TX (US)

(21) Appl. No.: 19/019,267

(22) Filed: Jan. 13, 2025

Related U.S. Application Data
(60) Provisional application No. 63/625,619, filed on Jan. 26, 2024.

(51) Int. Cl. H04W 52/02; H04L 5/00; H04W 4/06; H04W 72/1273

(52) U.S. Cl. CPC H04W 52/0225; H04L 5/0051; H04W 4/06; H04W 72/1273

(57) ABSTRACT

Methods and apparatuses for communication with variable cell coverage. A method for performing measurements by a user equipment (UE) includes receiving first information indicating a power of a reference signal, receiving second information indicating a set of offsets for the power of the reference signal, receiving third information indicating an offset from the set of offsets, and receiving the reference signal. The method further includes determining a reference signal received power (RSRP) based on the reference signal, the power of the reference signal, and the offset, determining a power of a signal based on the RSRP, and transmitting the signal based on the power.

### CROSS-REFERENCE TO RELATED AND CLAIM OF PRIORITY

The present application claims priority under 35 U.S.C. § 119 (e) to U.S. Provisional Patent Application No. 63/625,619 filed on Jan. 26, 2024, which is hereby incorporated by reference in its entirety.

### TECHNICAL FIELD

The present disclosure relates generally to wireless communication systems and, more specifically, the present disclosure relates to methods and apparatuses for communication with variable cell coverage.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to communication with variable cell coverage.

In one embodiment, a method for performing measurements by a user equipment (UE) is provided. The method includes receiving first information indicating a power of a reference signal, receiving second information indicating a set of offsets for the power of the reference signal, receiving third information indicating an offset from the set of offsets, and receiving the reference signal. The method further includes determining a reference signal received power (RSRP) based on the reference signal, the power of the reference signal, and the offset, determining a power of a signal based on the RSRP, and transmitting the signal based on the power.

In another embodiment, a UE is provided. The UE includes a transceiver configured to receive first information indicating a power of a reference signal, receive second information indicating a set of offsets for the power of the reference signal, receive third information indicating an offset from the set of offsets, and receive the reference signal. The UE further includes a processor operably coupled to the transceiver. The processor is configured to determine a RSRP based on the reference signal, the power of the reference signal, and the offset and determine a power of a signal based on the RSRP. The transceiver is further configured to transmit the signal based on the power.

In yet another embodiment, a base station is provided. The base station includes a transceiver configured to transmit first information indicating a power of a reference signal, transmit second information indicating a set of offsets for the power of the reference signal, transmit third information indicating an offset from the set of offsets, and transmit the reference signal. The base station further includes a processor operably coupled to the transceiver. The processor is configured to determine a number of repetitions for reception of a signal. The number of repetitions has a first value when the offset is a first offset from the set of offsets. The number of repetitions has a second value when the offset is a second offset from the set of offsets. The transceiver is further configured to receive the signal based on the number of repetitions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example synchronization signal/physical broadcast channel (SS/PBCH) block according to embodiments of the present disclosure;

FIG. 8 illustrates a flowchart of an example UE procedure for determining a transmission power according to embodiments of the present disclosure;

FIG. 9 illustrates a flowchart of an example UE procedure for determining a power offset according to embodiments of the present disclosure; and

FIG. 10 illustrates a flowchart of an example UE procedure for determining a set(s) of parameters according to embodiments of the present disclosure.

### DETAILED DESCRIPTION

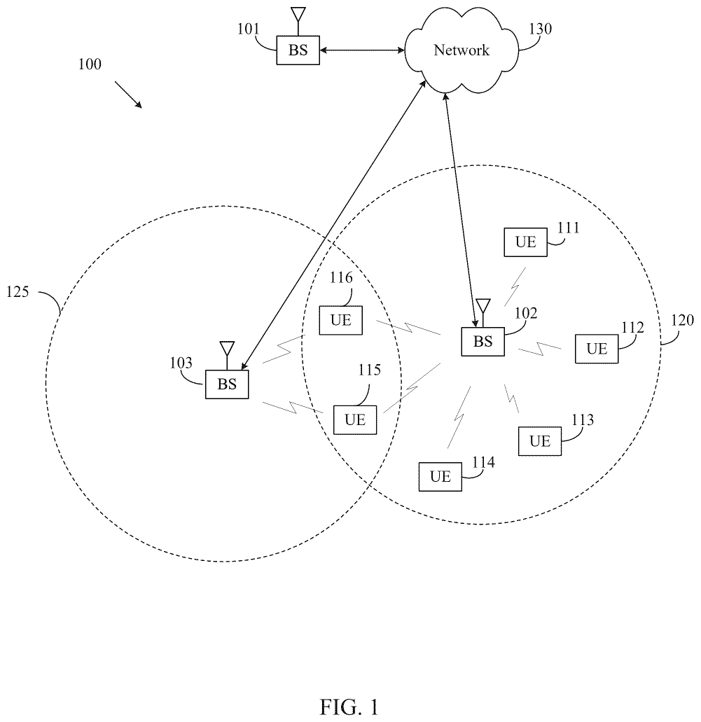

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.1.0, “NR; Physical channels and modulation;” [REF 2] 3GPP TS 38.212 v18.1.0, “NR; Multiplexing and channel coding;” [REF 3] 3GPP TS 38.213 v18.1.0, “NR; Physical layer procedures for control;” [REF 4] 3GPP TS 38.214 v18.1.0, “NR; Physical layer procedures for data;” [REF 5] 3GPP TS 38.321 v18.0.0, “NR; Medium Access Control (MAC) protocol specification;” and [REF 6] 3GPP TS 38.331 v18.0.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for communication with variable cell coverage. In certain embodiments, one or more of the gNBs 101-103 include circuitry, programing, or a combination thereof to support communication with variable cell coverage.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

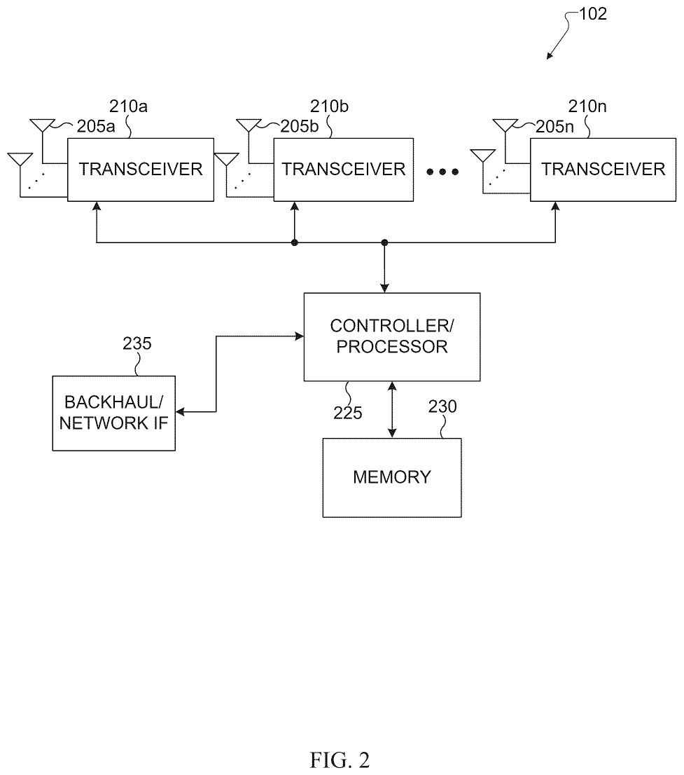

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting communication with variable cell coverage. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

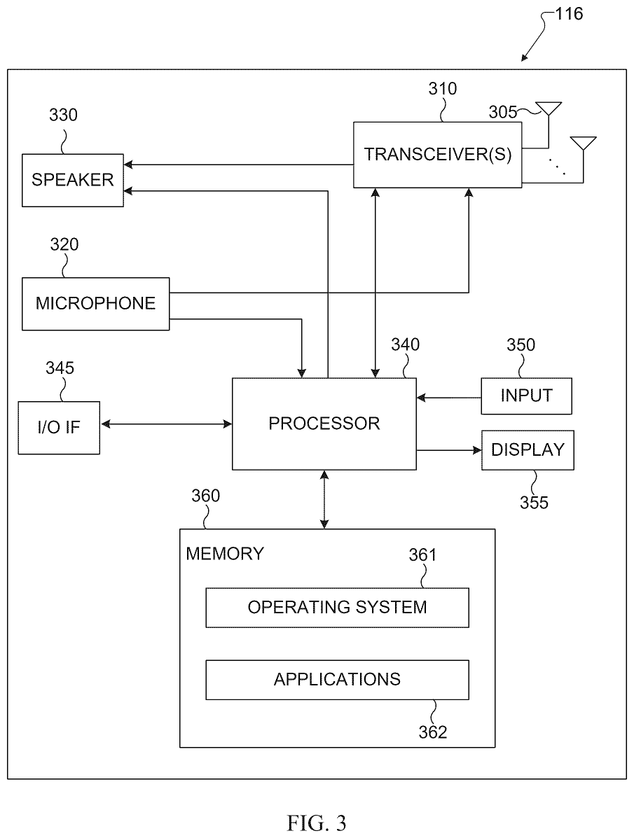

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform communication with variable cell coverage as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

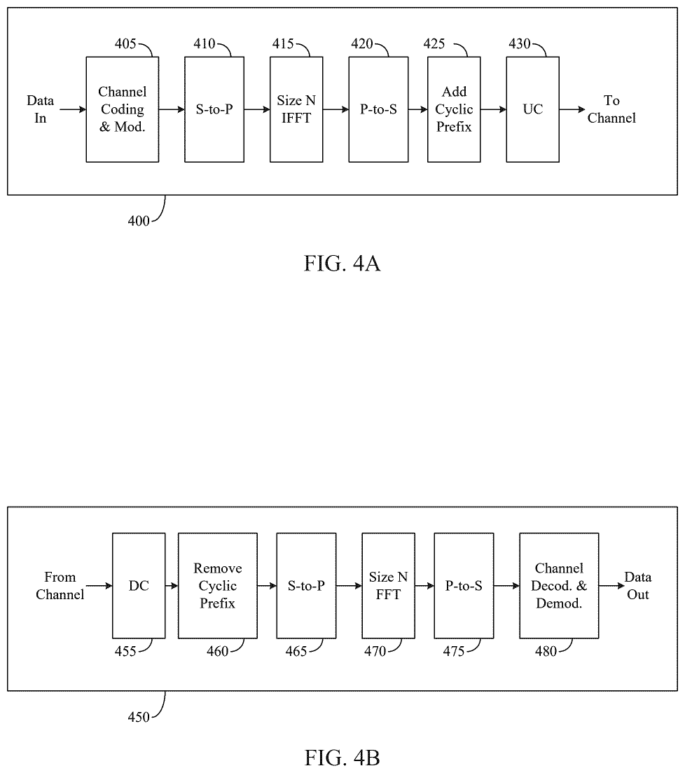

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 supports communication with variable cell coverage as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

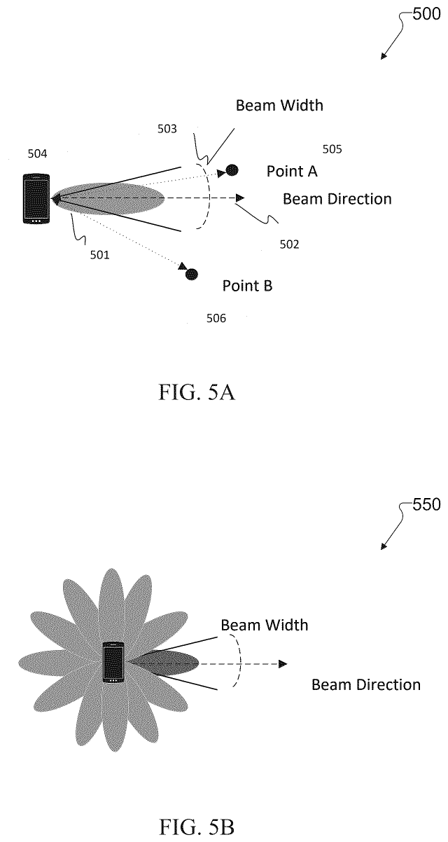

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

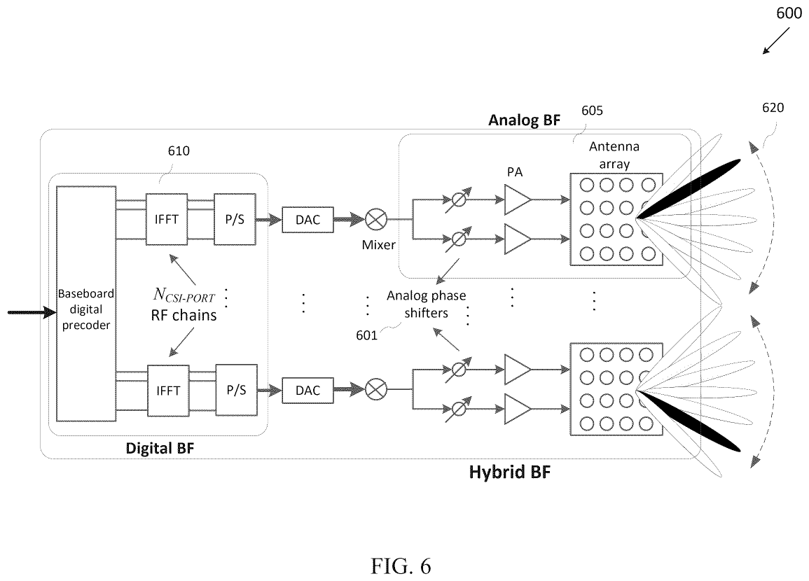

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In the following, an italicized name for a parameter implies that the parameter is provided by higher layers.

A unit for DL signaling or for UL signaling on a cell is referred to as a slot and can include a number of symbols such as fourteen symbols. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. A sub-carrier spacing (SCS) can be determined by a SCS configuration μ as 2^{μ}·15 kHz. A unit of one sub-carrier over one symbol is referred to as resource element (RE). A unit of one RB over one symbol is referred to as physical RB (PRB).

DL signals include data signals conveying information content, control signals conveying DL control information (DCI), and reference signals (RS). A gNB (e.g., the BS 102) transmits data information or DCI through respective physical DL shared channels (PDSCHs) or physical DL control channels (PDCCHs). A PDSCH or a PDCCH can be transmitted over a variable number of slot symbols including one slot symbol. A PDCCH transmission is over a number of control channel elements (CCEs) from a predetermined set of numbers of CCEs referred to as CCE aggregation level within a control resource set (CORESET).

A PDSCH transmission is scheduled by a DCI format or is semi-persistently scheduled (SPS) as configured by higher layers and activated by a DCI format. SPS PDSCH receptions can be according to one or more configurations for corresponding parameters that are provided by higher layers as described in [REF 6]. A PDSCH reception by a UE (e.g., the UE 116) provides one or more transport blocks (TBs), wherein a TB is associated with a hybrid automatic repeat request (HARQ) process that is indicated by a HARQ process number field in a DCI format scheduling the PDSCH reception or activating a SPS PDSCH reception. A TB transmission can be an initial one or a retransmission as identified by a new data indicator (NDI) field in the DCI format scheduling a PDSCH reception that provides a TB retransmission for a given HARQ process number.

A gNB transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement or for time tracking, non-zero power CSI-RS (NZP CSI-RS) resources are used. For interference measurement reports (IMRs), CSI interference measurement (CSI-IM) resources are used. The CSI-IM resources can also be associated with a zero power CSI-RS (ZP CSI-RS) configuration. A UE can determine CSI-RS reception parameters through DL control signaling or higher layer signaling, such as radio resource control (RRC) signaling from a gNB (see also [REF6]). A DM-RS is typically transmitted only within a BW of a respective PDCCH or PDSCH and a UE can use the DM-RS to demodulate data or control information symbols.

In this disclosure, a beam can be determined by any of the following and, in either case, the ID of the source reference signal identifies the beam
A transmission configuration indication (TCI) state, that establishes a quasi-colocation (QCL) relationship or spatial relation between a source reference signal (e.g. synchronization signal block (SSB) and/or CSI-RS) and a target reference signal
A spatial relation information that establishes an association to a source reference signal, such as SSB or CSI-RS or sounding reference signal (SRS).

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

NR Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations, for example as defined in [REF4]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS). A UE is indicated a TCI state by MAC CE when the CE activates one TCI state code point. The UE applies the TCI state code point after a beam application time from the corresponding hybrid automatic repeat request acknowledgement (HARQ-ACK) feedback. A UE is indicated a TCI state by a DL related DCI format (e.g., DCI format 1_1, or DCI format 1_2), wherein the DCI format includes a “transmission configuration indication” field that includes a TCI state code point out of the TCI state code points active by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

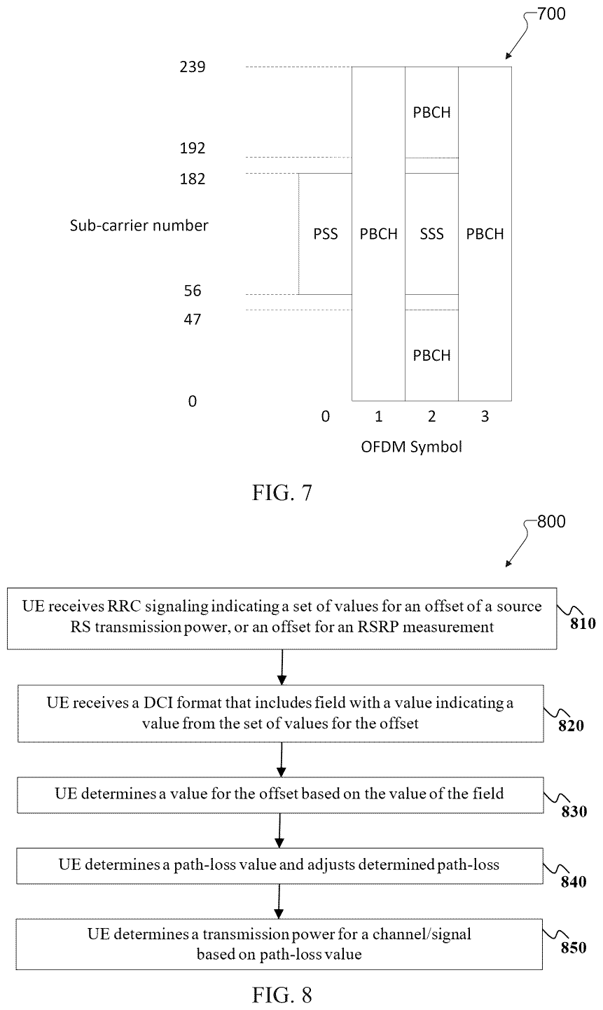

FIG. 7 illustrates a diagram of an example SS/PBCH block 700 according to embodiments of the present disclosure. For example, SS/PBCH block 700 can be received by any of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and including 4 consecutive symbols, and 20 physical blocks (240 subcarriers), as illustrated in FIG. 7.

SSBs are organized in groups of N SSBs, transmitted within half a frame, each SSB within the group has an index i, where i=0, 1, . . . , N−1, within each group of SSBs, the SSBs are time-division multiplexed and arranged in increasing order of i, with increasing time. For carrier frequencies less than or equal to 3 GHZ, N=4. For carrier frequencies in FR1 that are larger than 3 GHZ, N=8. For carrier frequencies in FR2, N=64. The SSB indices transmitted are provided by by ssb-PositionsInBurst in system information block one (SIB1) or in ServingCellConfigCommon.

SSBs are transmitted periodically. The allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

UL transmissions include channels providing data information or UL control information (UCI), DM-RS associated with demodulation of data information or UCI, sounding RS (SRS) enabling a gNB to perform channel measurements, and a random access (RA) preamble enabling a UE to perform random access. UCI includes hybrid automatic repeat request acknowledgement (HARQ-ACK) information, scheduling request (SR), and CSI reports. A UE transmits data information or UCI through a physical UL shared channel (PUSCH), UCI through a physical UL control channel (PUCCH), and a random access preamble through a physical random access channel (PRACH).

A UE can determine a transmission power for a PUSCH, PUCCH, SRS, or PRACH as described in [REF3]. For brevity, only the power control formula for a PUSCH transmission is evaluated in the following but the embodiments of this disclosure are directly applicable to the determination of a power for a PUCCH, SRS, or PRACH transmission in a similar manner. A simplified formula for a UE to determine a PUSCH transmission power is provided in Equation 1.

$${P}_{PUSCH} = min ( {P}_{CMAX} , {P}_{O \_ PUSCH} + 10 {log}_{10} ( {2}^{μ} \cdot {M}_{RB}^{PUSCH} ) + α \cdot P L + {Δ}_{TF} + f ) [ dBm ] \qquad ( Equation 1 )$$

In Equation 1, PL is a path-loss measurement by the UE, P_{O_PUSCH} is a target reception power for the PUSCH, and the remaining parameters are described in [REF3].

There are several motivations for a base station to use different transmission powers for different cells/TRPs/beams. For example, a different coverage area may be appropriate for some of the cells/TRPs/beams due to a corresponding topology. For example, when UEs associated with a beam are in good coverage conditions or do not require high data rates, a transmission power for the beam can be reduced to conserve energy. For example, when no UEs are served by a beam, transmissions using the beam can stop (reduce a transmission power to zero) in order conserve energy and avoid unnecessary interference. For example, when a total/maximum transmission power that is available for use across beams is predetermined, it may then be preferable to use a larger transmission power for beams that serve areas with coverage limitations, for example due to fading or blocking by the topology of the area served by the beam, and reduce the transmission power for beams that serve UEs having traffic that requires only limited QoS or stop transmissions from beams that do not serve any UEs.

When a transmission power for a beam increases, a DL coverage area for channels transmitted using the beam, for a given data rate, also respectively increases. However, there is no increase on the UL coverage for channels transmitted by UEs. Also, as a transmission power from a UE depends on the path-loss that the UE experiences towards a cell/TRP/beam, for example as determined by the UE based on reference signal received power (RSRP) measurements from an SS/PBCH block or a CSI-RS transmitted by or associated with the cell/TRP/beam, the transmission power by the UE may be incorrect, for example when a beam serving the UE changes or when a transmission power of the beam changes.

For example, a UE connected to a cell/TRP/beam using a larger transmission power than a nominal (unscaled) transmission power, may determine an RSRP that is larger than a nominal RSRP, and therefore determine a smaller path-loss and transmit with a smaller power than the one required to achieve a respective target reception reliability for the information provided by a channel. A UE connected to a cell/TRP/beam using a smaller transmission power than a nominal transmission power, may determine an RSRP that is smaller than a nominal RSRP and therefore determine a larger path-loss and transmit with a larger power than the one required to achieve a respective target reception reliability for the information provided by a channel, thereby unnecessarily consuming power and creating interference.

To enable a cell/TRP/beam to quickly adapt to traffic variations for energy savings or for improving utilization of a total transmission power across cells/TRPs/beams, embodiments of the present disclosure recognizes that it is beneficial to provide mechanisms and procedures to inform UEs served by the cell/TRP/beam of changes in an associated transmission power from the cell/TRP/beam.

The present disclosure relates to a 5G/NR and/or 6G communication system.

This disclosure evaluates aspects related to supporting operation in a network (e.g., the network 130) using different transmission powers per cell/TRP/beam or using variable transmission power per cell/TRP/beam, including zero power when the network does not transmit using the cell/TRP/beam. Such aspects include power control mechanisms for transmission of channels/signals, mechanisms for indicating a change in transmission per beam or per group of beams, and others.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, both frequency division duplexing (FDD) and time division duplexing (TDD) are evaluated as a duplex method for DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure evaluates several components that can be used in conjunction or in combination with one another, or can operate as standalone schemes.

In this disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is provided to a specific UE or (3) UE-group RRC signaling. A parameter name in italics denotes a parameter provided by RRC signaling.

In this disclosure MAC CE signaling can be UE-specific e.g., to one UE and can be UE common (e.g., to a group of UEs).

In this disclosure L1 control signaling includes: (1) DL control information (e.g., DCI on PDCCH) and/or (2) UL control information (e.g., UCI on PUCCH or PUSCH). L1 control signaling be UE-specific e.g., to one UE and can be UE common (e.g., to a group of UEs).

In this disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network/base station (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, a transmission power, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SS/PBCH block) with the result of the measurement used for calculating a beam report (e.g., including at least one L3-RSRP/L3-signal-to-interference-plus-noise ratio (SINR), or L1-RSRP/L1-SINR accompanied by at least one CSI-RS resource indicator (CRI) or SSB resource indicator (SSBRI)). Optionally or alternatively, the source RS can be transmitted by the UE (in this case, the source RS is an uplink measurement signal such as SRS).

FIG. 8 illustrates a flowchart of an example UE procedure 800 for determining a transmission power according to embodiments of the present disclosure. For example, procedure 800 can be performed by any of the UEs 111-116 of FIG. 1. This example is for illustration only and other embodiments can be used without departing from the scope of the present disclosure.

The UE receives RRC signaling indicating a set of values for an offset of a source RS transmission power, or an offset for an RSRP measurement 810. The UE receives a DCI format that includes field with a value indicating a value from the set of values for the offset 820. The UE determines a value for the offset based on the value of the field 830. The UE determines a path-loss value and adjusts the determined path-loss value based on the value for the offset 840. The UE determines a transmission power for a channel/signal based on the path-loss value 850.

A NW/gNB can inform a UE of a power offset applied to the source RS that the UE uses to measure RSRP and determine a path-loss. Equivalently, for a source RS that the UE uses to measure RSRP, the NW/gNB can inform the UE of an RSRP offset. In the following, when referring to a transmission power of a SS/PBCH block, the transmission power can be the transmission power of the SSS of the SS/PBCH block and other components (PSS or PBCH) of the SS/PBCH block may have a different transmission power.

In a first approach, information for a power offset value, or an RSRP offset value, is provided by UE-specific RRC signaling. For example, ServingCellConfigCommonSIB or ServingCellConfigCommon can provide a cell specific value of ss-PBCH-BlockPower, that is the average energy per resource element (EPRE) of REs with SSS in dBm, and ServingCellConfig can provide a value for a new parameter, ss-PBCH-BlockPower-Offset, that is an offset, for example in dBm or a scaling factor, from the value provided by ss-PBCH-BlockPower for the SS/PBCH block that the UE uses to perform RSRP measurements. For an RSRP offset value, a parameter RSRP-offset can be used.

In a second approach, information for the power offset value is provided by cell-common RRC signaling. For example, ServingCellConfigCommonSIB or ServingCellConfigCommon can provide a cell specific value of ss-PBCH-BlockPower and also provide a value for a new parameter, ss-PBCH-BlockPower-Offset, that is an offset, for example in dBm or a scaling factor, from the value provided by ss-PBCH-BlockPower for each SS/PBCH block indicated by ssb-PositionsInBurst.

In a third approach, information for the power offset value is provided by a MAC CE. A UE can be provided by UE-specific RRC, for example in ServingCellConfig, or by cell-common RRC, for example in ServingCellConfigCommonSIB or ServingCellConfigCommon, a set of power offset values for one or more SS/PBCH blocks, for example by ss-PBCH-BlockPower-Offset, and one value from the set of power offset values is indicated by a MAC CE for each of the one or more SS/PBCH blocks. The indicated value can become effective after a predetermined time, such as 4 msec or 4 subframes, after a slot where the UE provides (positive) HARQ-ACK information for a PDSCH reception that includes the MAC CE. Similar, for RSRP offset values, a parameter RSRP-offset can provide a set of RSRP offset values and the MAC CE can indicate one of them.

In a fourth approach, information for the power offset value or for the RSRP offset value for a SS/PBCH block is provided by a field in a DCI format. The DCI format can be provided in a PDCCH that a UE monitors according to a UE-specific search space (USS) set or according to a common search space (CSS) set. A procedure for providing power offset values or RSRP offset values by a DCI format is subsequently described.

For the previous approaches, a parameter ssb-PositionsInBurst can indicate time domain positions of transmitted SS/PBCH blocks in a half frame. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted. In this manner, each SS/PBCH block can be associated with a different transmission power that is given by a sum of a nominal power (ss-PBCH-BlockPower) that is common to each SS/PBCH block and a corresponding power offset (ss-PBCH-BlockPower-Offset) that is specific to each SS/PBCH block (or groups of SS/PBCH blocks that can also be indicated in ServingCellConfigCommonSIB or ServingCellConfigCommon). Similar, for RSRP offset values, a parameter RSRP-offset can be used.

The information for the power offset or for the RSRP offset can be included in a separate information element/field, for example when provided by cell-specific RRC signaling, or as part of another information element/field, for example when provided by UE-specific RRC signaling or a MAC CE or a DCI format. For example, a power offset can be included in the configuration of a TCI state, that is provided for example as described in [REF 5] or [REF 6].

The descriptions herein are also directly applicable for a power offset or for a RSRP offset associated with a CSI-RS transmission, by replacing corresponding parameters for SS/PBCH blocks (or for the SSS of SS/PBCH blocks) with ones for CSI-RS, and for brevity they are not repeated in the case of CSI-RS transmission.

A UE adjusts an RSRP measurement by adding an indicated offset for a transmission power or RSRP associated with a source RS, such as a SSS of a SS/PBCH block or a CSI-RS. For example, with reference to RSRP, denoting by RSRP_{offset} a value of the indicated offset and by RSRP a value of the RSRP that the UE measures, the UE computes an adjusted RSRP as RSRP+RSRP_{offset}. The RSRP offset can be a negative value when the transmission power of the source RS increases and a positive value otherwise. Based on the transmitted power of the source RS, for example as provided by a value of ss-PBCH-BlockPower, the UE determines a (linear) path-loss value PL, for example as PL=ss-PBCH-BlockPower-(RSRP+RSRP_{offset}). The UE determines a transmission power of a channel/signal using the path-loss PL that the UE determines using the RSRP_{offset}. Alternatively, when the indicated offset is with respect to the source RS transmission power instead of the RSRP, the UE determines a path-loss value as PL=ss-PBCH-BlockPower+ss-PBCH-BlockPower-Offset-RSRP.

In determining a PUSCH, PUCCH, SRS, or PRACH transmission power, the UE sets the path-loss value to the value the UE determines according to the applicable one of the two derivations herein (based on the RSRP offset or based on the transmission power offset). The path-loss value can be additionally adjusted from a linear value to a base-10 logarithmic value in dB. Therefore, the UE does not adjust a transmission power for a channel/signal transmission based on a common RSRP measurement and instead the UE adjusts (subtracts from) the RSRP measurement according to the indicated power offset for the SS/PBCH block (or for the SSS of the SS/PBCH block).

With reference to FIG. 8, a procedure is shown for a UE to determine a transmission power for a channel/signal based on an offset for a SS/PBCH block transmission power, or an offset for an RSRP measurement, that is indicated by a DCI format.

In a fifth approach, denoting by P_{scale} a linear factor for scaling a nominal transmission power, Pₙₒₘᵢₙₐₗ, of a source RS that a UE uses for RSRP measurements, such that a resulting linear transmission power is P_{scale}. Pₙₒₘᵢₙₐₗ, the path-loss is also proportional to P_{scale}. Then, after the operation α·10 log₁₀(PL) to convert the linear path-loss value to the dB domain, a term α·10 log₁₀(P_{scale}) can be extracted, does not depend on the propagation medium, and can be incorporated in the value of P_{O_PUSCH}, such as in the cell-specific component of P_{O_PUSCH}, in Equation 1. With the fifth approach, there is no need for a gNB to signal a transmission power offset or an RSRP offset for a source RS that a UE uses to obtain a path-loss measurement for power control, and the gNB can instead signal an offset to the P_{O_PUSCH} value, for example for the cell-specific component of the P_{O_PUSCH} value as that value is defined in [REF 3]. The signaling of the offset to the P_{O_PUSCH} value can be based on similar mechanisms as in the approaches mentioned herein and can be provided either by RRC signaling, such as cell-specific RRC signaling in a SIB as part of an SS/PBCH block configuration or UE-specific RRC signaling as part of a CSI-RS configuration or of a TCI state configuration, or by a MAC CE in a PDSCH, or by a DCI format in a PDCCH.

A base station can also inform a UE (e.g., the UE 116) whether or not to adjust a path-loss measurement in response to a power offset applied to the source RS that the UE uses to measure RSRP and determine the path-loss measurement.

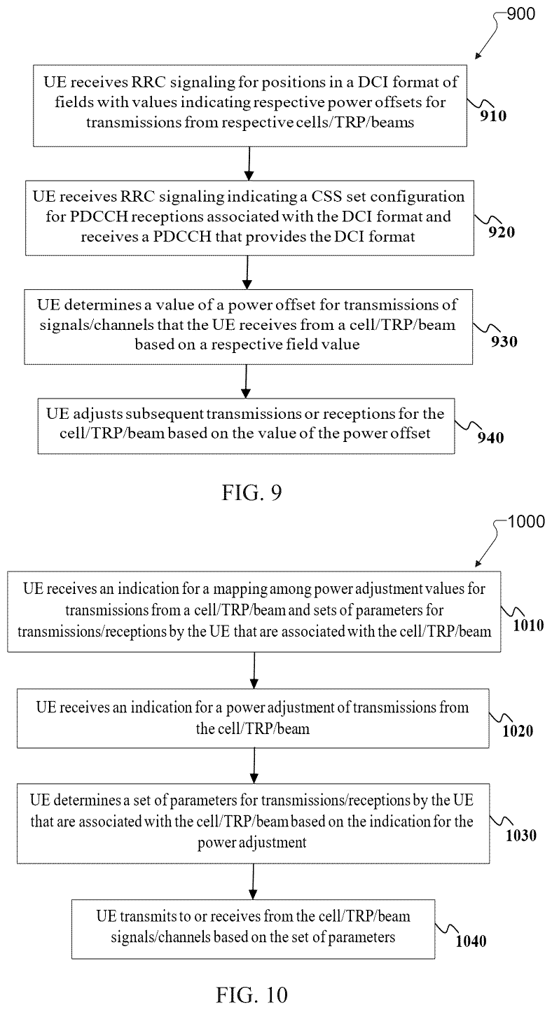

FIG. 9 illustrates a flowchart of an example UE procedure 900 for determining a power offset according to embodiments of the present disclosure. For example, procedure 900 can be performed by the UE 116 of FIG. 3. This example is for illustration only and other embodiments can be used without departing from the scope of the present disclosure.

UE receives RRC signaling for positions of fields in a DCI format, wherein the values of the fields indicate respective power offsets for transmissions from respective cells/TRP/beams 910. The UE can additionally receive RRC signaling indicating a number of bits per field or receive RRC signaling indicating a mapping for values of a field to power offset values; alternatively, the number of bits or the mapping can be defined in the specifications of the system operation. The UE also receives RRC signaling indicating a search space set configuration, such as a CSS set configuration, for PDCCH receptions associated with the DCI format. The UE receives a PDCCH that provides the DCI format 920. The UE determines a value of a power offset for transmissions of signals/channels that the UE receives from a cell/TRP/beam based on a respective field value in DCI 930. The UE adjusts subsequent transmissions or receptions for the cell/TRP/beam based on the value of the power offset 940.

For various purposes, such as for energy savings or to improve robustness to mobility, a base station may change the beamwidth of some beams. For example, the base station may stop transmissions from a first beam and increase the beamwidth of a second beam in order to maintain a same coverage area for the two beams while also increasing, such as doubling, the transmission power of some signals associated with the second beam when that is needed to maintain coverage. A UE can be configured multiple TCI states or SS/PBCH block indexes and the gNB (e.g., the BS 102) can indicate to the UE a TCI state or a SS/PBCH block for QCL reference (source RS) for channel/signal receptions by the UE, and thereby indicate a corresponding beam. Then, a path-loss measured by the UE does not change as a result of a change in the transmission power of the source RS by the gNB when the beam associated with the source RS changes. For example, a DCI format as the one for the fourth approach that is subsequently described, can additionally or alternatively indicate a source RS for a cell/TRP/beam by indicating a TCI state for a CSI-RS or an index for an SS/PBCH block.

For example, when a transmission power for a beam/TCI state doubles and the beam remains same or changes from a different beam/TCI state of similar beamwidth, the path-loss measured by the UE needs can be adjusted to account for the increase in power. Conversely, when a transmission power for a beam/TCI state doubles and the beamwidth also doubles, the path-loss measured by the UE need not be adjusted to account for the increase in power or may need to be adjusted for some beamwidths, such as narrower beamwidths, and not adjusted for other beamwidths, such as wider beamwidths. Considering that a UE has fewer transmitter antenna elements than a gNB, the narrowest beamwidth that the UE is capable of transmitting with is larger than narrowest beamwidth that the gNB is capable of transmitting with. For example, if the smallest beamwidth achievable by the UE is 30 degrees, while the smallest beamwidth achievable by the gNB is 10 degrees.

Therefore, in order to enable a gNB to transmit using different transmission powers for different beams, including for different beamwidths for different beams, associated with respective source RSs for RSRP/path-loss measurements, it is beneficial to signal to a UE whether a path-loss adjustment is needed as a result of using different transmission powers for different beams. A gNB can use a parameter/field to indicate whether or not a UE should apply a path-loss adjustment when the gNB changes the transmission power of a source RS that the UE uses for RSRP measurements. For example, together with an indication of a change in a source RS and in a transmission power of the source RS to a UE, the gNB can also indicate whether the UE adjusts an RSRP/path-loss measurement according to the chance in the transmission power.

For higher-layer filtered RSRP, also referred to as L3-RSRP, a UE can adjust RSRP measurements before a change in the source RS transmission power, for example by scaling those measurements with the linear value of the change in the source RS transmission power to determine the L3-RSRP value. Alternatively, the UE can adjust RSRP measurements after a change in the source RS transmission power, for example by scaling those measurements with the inverse of the linear value of the change in the source RS transmission power to determine the L3-RSRP value. In another approach, the UE may discard RSRP measurements prior to a change in the source RS transmission power. For RSRP measurements based at the physical layer, also referred to as L1-RSRP, the UE can use the most recent adjustment in the source RS transmission power that is determined based on the most recent indication for the source RS transmission power offset that the UE receives prior to the measurement. An additional timeline for the UE to process the indication for the most recent indication for the source RS transmission power offset can also be included, such as for example 4 milliseconds after a slot when the UE transmits a channel with HARQ-ACK information associated with a PDSCH providing the source RS transmission power offset.

According to the fourth approach, the gNB can indicate a power offset for transmissions from a cell/TRP/beam in a DCI format provided in a PDCCH reception according to a CSS set. For example, the power offset can be for transmission of an SS/PBCH block (or for the SSS of the SS/PBCH block) from a cell. For example, the power offset can be for transmission of a CSI-RS from a TRP or from a beam of a cell/TRP. A cell can be identified by a respective cell index (cell ID). A TRP can be identified by a respective CORESETPoolIndex as described in [REF 3] for a given cell index, or by a TRP index. A beam can be identified by a corresponding TCI state, such as for a CSI-RS transmission, or by an SS/PBCH block index that defines QCL properties for the beam.

The gNB can indicate multiple power offsets for transmissions on respective multiple cells/TRPs/beams in the DCI format. The transmission power offset can include the value of 0, for example when the gNB stops transmitting on a respective cell/TRP/beam, and the value of 1 when the gNB transmits with a same power as the one indicated in a SIB, for example by ss-PBCH-BlockPower for a SS/PBCH block and by powerControlOffsetSS for a CSI-RS that provides a power offset, for example in dB, of the nonzero power (NZP) CSI-RS RE to SSS RE.

Additional values, if any, for the transmission power offset of a SS/PBCH block (or for the SSS of the SS/PBCH block) or for the CSI-RS can be smaller than 1, such as when the gNB operates with reduced energy or with decreased coverage area for a cell/TRP/beam, or larger than one such as when the gNB increases the coverage area for the cell/TRP/beam. For example, power scaling with a positive value smaller than 1 can be beneficial as an intermediate step in transitioning a cell/TRP/beam towards no transmissions while maintaining service to UEs that are in proximity to the transmission point of the cell/TRP/beam and cannot be moved to another cell/TRP/beam via a handover. For example, power scaling with a positive value larger than 1 can be beneficial for increasing coverage or data rates for a cell/TRP/beam and, also, to serve UEs that were previously served by another cell/TRP/beam that transitioned to no transmissions.

The power scaling can also be evaluated to apply to transmissions of signals/channels on a cell/TRP/beam and does not need to be limited to SS/PBCH blocks or CSI-RS.

For each cell/TRP/beam, the UE can also be indicated a location in the DCI format for a power offset field and a mapping of the values for the power offset field to power offset values for transmissions from the cell/TRP/beam. In case of a cell, the location can be associated with a cell index. In case of a TRP, the location can be associated with a cell index and a TRP index, such as a CORESETPoolIndex value as described in [REF 3]. In case of a beam, the location can be associated with a cell index and a TCI state index. For example, for a cell where a UE is configured to receive with any of four TCI states, there can be four locations for four respective power offset fields in the DCI format.

Additionally, the UE can be indicated a number of bits for the power offset field for each cell/TRP/beam, such as one bit or two bits. For example, in case of one bit, a first value can indicate that there are no corresponding transmissions, such as SS/PBCH block or CSI-RS transmissions, and a second value can indicate that there are corresponding transmissions, such as SS/PBCH block or CSI-RS transmissions. For example, in case of two bits, a first/second/third/fourth value can respectively indicate that there are no transmissions, and that there are transmissions with a power indicated by a higher layer parameter after applying an offset with a first, second, or third value. One of the offset values can be specified to be equal to one.

With reference to FIG. 9, a procedure is shown for a UE to determine a power offset for transmissions from a cell/TRP/beam based on a field in a DCI format.

FIG. 10 illustrates a flowchart of an example UE procedure 1000 for determining a set(s) of parameters according to embodiments of the present disclosure. For example, procedure 1000 can be performed by the UE 115 of FIG. 1. This example is for illustration only and other embodiments can be used without departing from the scope of the present disclosure.

The UE receives an indication for a mapping among power adjustment values for transmissions from a cell/TRP/beam and sets of parameters for transmissions/receptions by the UE that are associated with the cell/TRP/beam 1010. The UE receives an indication for a power adjustment of transmissions from the cell/TRP/beam, such as for a SS/PBCH block or a CSI-RS transmission 1020. The UE determines a set of parameters for transmissions/receptions by the UE that are associated with the cell/TRP/beam based on the indication for the power adjustment 1030. The UE transmits to or receives from the cell/TRP/beam signals/channels based on the set of parameters 1040.

Depending on a power offset value, when it is not 0, the UE can additionally determine set of parameters for transmissions/receptions of channels/signals associated with a cell/TRP/beam.

For example, when a first power offset value that is larger than one is indicated, the cell/TRP/beam coverage area on the DL is larger than a nominal one (corresponding to a power offset value of 1), while when a second power offset value that is smaller than one is indicated, the cell/TRP/beam coverage area on the DL is smaller than the nominal one. Then, when a UE transmits a channel with repetitions, the UE can be indicated a first number of repetitions from a first set of numbers of repetitions when the first power offset value applies and can be indicated a second number of repetitions from a second set of numbers of repetitions when the second power offset value applies. As the UE may need to transmit the channel with more repetitions on the cell when the DL coverage area of the cell increases, a maximum number in the first set of numbers of repetitions can be larger than a maximum number in the second set of numbers of repetitions.

For example, the UE can be configured first search space sets and second search space sets and monitor PDCCH according to the first search space sets or according to the second search space sets depending on whether the first power offset value or the second power offset value applies. For example, the search space sets can have different numbers of PDCCH candidates per CCE aggregation level or different periodicities for receptions of PDCCH candidates.

For example, the UE can be configured a first and second sets of power control parameters, such as a path-loss compensation factor α, and determine a power for a channel transmission, such as a PUSCH, using the first set or the second set of power control parameters.

With reference to FIG. 10, a procedure is shown for a UE to determine one or more sets of parameters for transmissions/receptions associated with a cell/TRP/beam based on a transmission power indication for transmissions from the cell/TRP/beam.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

1. A method for performing measurements by a user equipment (UE), the method comprising:
receiving first information indicating a power of a reference signal;
receiving second information indicating a set of offsets for the power of the reference signal;
receiving third information indicating an offset from the set of offsets;
receiving the reference signal;
determining a reference signal received power (RSRP) based on:
the reference signal,
the power of the reference signal, and
the offset;
determining a power of a signal based on the RSRP; and
transmitting the signal based on the power.

2. The method of claim 1, wherein the reference signal is a synchronization signal and primary broadcast channel (PBCH) block.

3. The method of claim 1, wherein:
receiving the first and second information further comprises receiving the first and second information in a system information block (SIB), and
receiving the third information further comprises receiving the third information in a downlink control information (DCI) format or a medium access control (MAC) control element (CE).

4. The method of claim 1, wherein:
a first offset from the set of offsets is associated with first quasi co-location properties for the reference signal, and
a second offset from the set of offsets is associated with second quasi co-location properties for the reference signal.

5. The method of claim 1, further comprising:
determining a number of repetitions for transmission of the signal, wherein:
the number of repetitions has a first value when the offset is a first offset from the set of offsets,
the number of repetitions has a second value when the offset is a second offset from the set of offsets, and
transmitting the signal further comprises transmitting the signal based on the number of repetitions.

6. The method of claim 1, further comprising:
determining search space sets for receptions of physical downlink control channels (PDCCHs), wherein:
the search space sets are first search space sets when the offset is a first offset from the set of offsets, and
the search space sets are second search space sets when the offset is a second offset from the set of offsets; and
receiving the PDCCHs based on the search space sets.

7. The method of claim 1, further comprising:
receiving fourth information indicating a set of factors;
determining a factor from the set of factors, wherein:
the factor is a first factor when the offset is a first offset from the set of offsets, and
the factor is a second factor when the offset is a second offset from the set of offsets; and
determining a pathloss based on the RSRP,
wherein determining the power of the signal further comprises determining the power of the signal based on scaling the pathloss with the factor.

8. A user equipment (UE) comprising:
a transceiver configured to:
receive first information indicating a power of a reference signal,
receive second information indicating a set of offsets for the power of the reference signal,
receive third information indicating an offset from the set of offsets, and
receive the reference signal; and
a processor operably coupled to the transceiver, the processor configured to:
determine a reference signal received power (RSRP) based on:
the reference signal,
the power of the reference signal, and
the offset, and
determine a power of a signal based on the RSRP,
wherein the transceiver is further configured to transmit the signal based on the power.

9. The UE of claim 8, wherein the reference signal is a synchronization signal and primary broadcast channel (PBCH) block.

10. The UE of claim 8, wherein the transceiver is further configured to:
receive the first information and the second information in a system information block (SIB), and
receive the third information in a downlink control information (DCI) format or a medium access control (MAC) control element (CE).

11. The UE of claim 8, wherein:
a first offset from the set of offsets is associated with first quasi co-location properties for the reference signal, and
a second offset from the set of offsets is associated with second quasi co-location properties for the reference signal.

12. The UE of claim 8, wherein:
the processor is further configured to determine a number of repetitions for transmission of the signal,
the number of repetitions has a first value when the offset is a first offset from the set of offsets,
the number of repetitions has a second value when the offset is a second offset from the set of offsets, and
the transceiver is further configured to transmit the signal based on the number of repetitions.

13. The UE of claim 8, wherein:
the processor is further configured to determine search space sets for receptions of physical downlink control channels (PDCCHs),
the search space sets are first search space sets when the offset is a first offset from the set of offsets,
the search space sets are second search space sets when the offset is a second offset from the set of offsets, and
the transceiver is further configured to receive the PDCCHs based on the search space sets.

14. The UE of claim 8, wherein:
the transceiver is further configured to receive fourth information fourth information indicating a set of factors; and
the processor is further configured to:
determine a factor from the set of factors, wherein:
the factor is a first factor when the offset is a first offset from the set of offsets, and
the factor is a second factor when the offset is a second offset from the set of offsets,
determine a pathloss based on the RSRP, and
determine the power of the signal based on scaling the pathloss with the factor.

15. A base station comprising:
a transceiver configured to:
transmit first information indicating a power of a reference signal,
transmit second information indicating a set of offsets for the power of the reference signal,
transmit third information indicating an offset from the set of offsets, and
transmit the reference signal; and
a processor operably coupled to the transceiver, the processor configured to determine a number of repetitions for reception of a signal, wherein:
the number of repetitions has a first value when the offset is a first offset from the set of offsets, and
the number of repetitions has a second value when the offset is a second offset from the set of offsets,
wherein the transceiver is further configured to receive the signal based on the number of repetitions.

16. The base station of claim 15, wherein the reference signal is a synchronization signal and primary broadcast channel (PBCH) block.

17. The base station of claim 15, wherein the transceiver is further configured to:
transmit the first information and the second information in a system information block (SIB), and
transmit the third information in a downlink control information (DCI) format or a medium access control (MAC) control element (CE).

18. The base station of claim 15, wherein:
a first offset from the set of offsets is associated with first quasi co-location properties for the reference signal, and
a second offset from the set of offsets is associated with second quasi co-location properties for the reference signal.

19. The base station of claim 15, wherein:
the processor is further configured to determine search space sets for receptions of physical downlink control channels (PDCCHs),
the search space sets are first search space sets when the offset is a first offset from the set of offsets,
the search space sets are second search space sets when the offset is a second offset from the set of offsets, and
the transceiver is further configured to receive the PDCCHs based on the search space sets.

20. The base station of claim 15, wherein:
the transceiver is further configured to transmit fourth information related to a factor, and
the factor is used for scaling a pathloss associated with the signal.
